(19) United States
(12) Patent Application Publication
(10) Pub. No.: US 2007/0287137 A1
(43) Pub. Date: Dec. 13, 2007

(54) Soft, fabric, animal head/face book with an attached blanket

(76) Inventor: Sheryl Crawford, Santa Clarita, CA (US)

Correspondence Address: CISLO & THOMAS, LLP, 233 WILSHIRE BLVD, SUITE 900, SANTA MONICA, CA, 90401-1211, US

(21) Appl. No.: 11/800,823

(22) Filed: May 8, 2007

Related U.S. Application Data
(60) Provisional application No. 60/804,589, filed on Jun. 13, 2006.

(51) Int. Cl. G09B 17/00

(52) U.S. Cl. 434/178

(57) ABSTRACT

An apparatus and corresponding methods for teaching and encouraging reading. The apparatus involves a soft, fabric animal head/face book which is permanently attached to a blanket for providing comfort, play, education, entertainment, and amusement to young children. The book is fabric with front and back covers as well as fabric pages. The front cover has an animal face portrayal; and the rear cover has a pair of animal ears portrayal. Text may be disposed on a left page; and a varying expression of the animal face portrayal on the opposite page. The pages may also have a combination of text and illustrations.

### CROSS-REFERENCE TO RELATED APPLICATION(S)

This document is a non-provisional patent application which is related to, and claims priority from, U.S. Provisional Patent Application Ser. No. 60/804,589, entitled “A Soft, Fabric, Animal Head/Face with Attached Blanket,” filed on Jun. 13, 2006.

### TECHNICAL FIELD

The present invention technically relates to apparatuses and methods for encouraging young children to read. More particularly, the present invention technically relates to literary and illustrative apparatuses and methods for encouraging young children to read. Even more particularly, the present invention technically relates to literary and illustrative apparatuses and methods having a comforting feature, for encouraging young children to read.

### BACKGROUND ART

The currently existing related art involves several apparatuses for encouraging young children to read. One such invention is a fabric book for teaching and encouraging young children to read that comprises a rudimentary story line and illustrations for small children, the book being attached thereto a dimensional character, i.e., having some projection from the front cover, in the form of a rabbit and a plastic split-ring, and wherein the book is finished with a seam-binding. Another related art invention comprises a fabric book for teaching and encouraging young children to pray that comprises a rudimentary story line and illustrations for small children, the book being attached thereto a dimensional character, also having some projection from the front cover, in the form of a bear, and the book being finished with a seam-binding. Yet another related art invention comprises a blanket and stuffed toy combination, the blanket being disposable within the stuffed toy when the blanket is not in use.

In addition, the related art involves the following apparatuses: a doll having a book disposed within its abdominal cavity, a book having a dimensional character disposed on its cover with straps binding the pages together, a rag-doll having a changeable facial expression feature, a zippered book having a character's image disposed on its cover, a soft book having a cavity, wherein a stuffed animal or a blanket may be disposed in the cavity, a soft sculpture being convertible to a blanket with a pillow, a stuffed animal having a pouch disposed at a vicinity of its abdomen, wherein a book or finger puppets may be disposed, and a book blanket comprising a blanket for covering a document. However, the related art inventions do not readily dispose the book in a young child's face while simultaneously providing a comforting element.

Thus, a long-felt need is seen to exist for an apparatus and a method for teaching and encouraging a young child to read which disposes the literary matter in the face of the young child and which provides a comforting element for facilitating the teaching and the encouragement.

### DISCLOSURE OF THE INVENTION

The present invention addresses the foregoing problems in the current art in the form of a soft, fabric, animal head/face book having an attached blanket and a corresponding method of its fabrication for teaching and encouraging a young child to read, wherein the literary matter is disposed in a position that faces the young child, and wherein a comforting element is provided for facilitating the teaching and encouragement of reading. The book would be disposed in the child's face while the child is reading while prone on the blanket. The blanket may be permanently attached to the book.

The present invention introduces a young child to the joy of reading at a very young age through an appealing combination of a book and an attached blanket. The present invention apparatus comprises a combination of the following elements: a blanket and a book, wherein the book comprises a huggable toy, e.g., having a nap and/or a cushioning feature, literary matter that appeals to a young child, and illustrative matter that appeals to a young child, wherein the blanket is snuggly, e.g., having a nap and/or a cushioning feature, literary matter that appeals to a young child, wherein the blanket is permanently attached to the book, wherein the literary matter comprises at least one element such as a story and a story line, wherein the illustrative matter comprises at least one illustration, whereby the young child is provided with oft-sought surrogate comfort and affection, and whereby a learning opportunity is seized for the young child. The book may further comprise a huggable toy, wherein the huggable toy comprises an element such as an animal head and an animal face. The young child may carry the apparatus with him/her all throughout the day as well as take the apparatus to bed as a nightly ritual.

The present invention also involves corresponding methods, e.g., a method of fabricating the present apparatus and a method of using the present apparatus. The method comprising the steps of: providing a blanket; providing a book; and attaching the blanket to the book, wherein the book providing step comprises providing a huggable toy, e.g., having a nap and/or a cushioning feature, literary matter that appeals to a young child, providing literary matter that appeals to a young child, and providing illustrative matter that appeals to a young child, wherein the blanket providing step comprises providing a snuggly blanket, e.g., having a nap and/or a cushioning feature, literary matter that appeals to a young child, wherein the attaching step comprises permanently attaching the blanket to the book, wherein the literary matter providing step comprises providing at least one element such as a story and a story line, wherein the illustrative matter comprises at least one illustration, thereby providing the young child with oft-sought surrogate comfort and affection, and thereby seizing a learning opportunity for the young child. The book providing step may further comprise providing a huggable toy, wherein the huggable toy providing step comprises providing an element such as an animal head and an animal face. A method of using the apparatus comprises: carrying the apparatus by the young child throughout the day and taking the apparatus to bed by the young child as a nightly ritual.

Advantages of the present invention include, but are not limited to: teaching the joy of reading to a young child, encouraging reading by a young child, optimizing a learning opportunity in the young child, and providing surrogate comfort and affection to a young child. Other features of the present invention are disclosed, or are apparent, in the section entitled “Mode(s) for Carrying-Out the Invention,” disclosed, infra.

### BRIEF DESCRIPTION OF THE DRAWING(S)

For a better understanding of the present invention, reference is made to the below-referenced accompanying Drawing(s). Reference numbers refer to the same or equivalent parts of the present invention throughout the several figures of the Drawing(s).

FIG. 1 is a front elevation view of a teaching and encouraging apparatus, the apparatus comprising a book and a blanket attached to the book, wherein the book comprises a portrayal of an animal head, wherein the animal head portrayal comprises a bear head portrayal, wherein the book comprises a front cover and a back cover, and wherein the front cover comprises a face and the back cover comprises a pair of ears, in accordance with the present invention.

FIG. 2 is a side elevation view of a teaching and encouraging apparatus, the apparatus comprising a book and a blanket attached to the book, wherein the book comprises a portrayal of an animal head, wherein the animal head portrayal comprises a bear head portrayal, wherein the book comprises a front cover and a back cover, and wherein the front cover comprises a face and the back cover comprises a pair of ears, in accordance with the present invention.

FIG. 3 is an opposing side elevation view of a teaching and encouraging apparatus, the apparatus comprising a book and a blanket attached to the book, wherein the book comprises a portrayal of an animal head, wherein the animal head portrayal comprises a bear head portrayal, wherein the book comprises a front cover and a back cover, and wherein the front cover comprises a face and the back cover comprises a pair of ears, in accordance with the present invention.

FIG. 4 is a front cut-away enlarged view of a teaching and encouraging apparatus, the apparatus comprising a book and a blanket attached to the book, wherein the book comprises a portrayal of an animal head, wherein the animal head portrayal comprises a bear head portrayal, wherein the book is being opened, wherein the book comprises a front cover and a back cover, and wherein the front cover comprises a face and the back cover comprises a pair of ears, in accordance with the present invention.

FIG. 5 is a front elevation view of a teaching and encouraging apparatus, the apparatus comprising a book and a blanket attached to the book, wherein the book comprises a portrayal of an animal head, wherein the animal head portrayal comprises a bear head portrayal, wherein the book has been opened, wherein a page of the book is shown, wherein the book comprises a front cover and a back cover, and wherein the front cover comprises a face and the back cover comprises a pair of ears, in accordance with the present invention.

FIG. 6 is a front elevation view of a teaching and encouraging apparatus, the apparatus comprising a book and a blanket attached to the book, wherein the book comprises a portrayal of an animal head, wherein the animal head portrayal comprises a lamb head portrayal, wherein the book comprises a front cover and a back cover, and wherein the front cover comprises a face and the back cover comprises a pair of ears, in accordance with an alternative embodiment of the present invention.

FIG. 7 is a front elevation view of a teaching and encouraging apparatus, the apparatus comprising a book and a blanket attached to the book, wherein the book comprises a portrayal of an animal head, wherein the animal head portrayal comprises a tiger head portrayal, wherein the book comprises a front cover and a back cover, and wherein the front cover comprises a face and the back cover comprises a pair of ears, in accordance with an alternative embodiment of the present invention.

FIG. 8 is a front elevation view of a teaching and encouraging apparatus, the apparatus comprising a book and a blanket attached to the book, wherein the book comprises a portrayal of an animal head, wherein the animal head portrayal comprises a kitten head portrayal, wherein the book comprises a front cover and a back cover, and wherein the front cover comprises a face and the back cover comprises a pair of ears, in accordance with an alternative embodiment of the present invention.

FIG. 9 is a front elevation view of a teaching and encouraging apparatus, the apparatus comprising a book and a blanket attached to the book, wherein the book comprises a portrayal of an animal head, wherein the animal head portrayal comprises a bunny head portrayal, wherein the book comprises a front cover and a back cover, and wherein the front cover comprises a face and the back cover comprises a pair of ears, in accordance with an alternative embodiment of the present invention.

FIG. 10 is a front elevation view of a teaching and encouraging apparatus, the apparatus comprising a book and a blanket attached to the book, wherein the book comprises a portrayal of an animal head, wherein the animal head portrayal comprises a puppy head portrayal, wherein the book comprises a front cover and a back cover, and wherein the front cover comprises a face and the back cover comprises a pair of ears, in accordance with an alternative embodiment of the present invention.

FIG. 11 is a flowchart for a method of fabricating an apparatus for teaching and encouraging reading in a young child, in accordance with the present invention.

FIG. 12 is a flowchart for a method of teaching and encouraging reading in a young child by way of a teaching and encouraging apparatus, in accordance with the present invention.

### MODE(S) FOR CARRYING OUT THE INVENTION

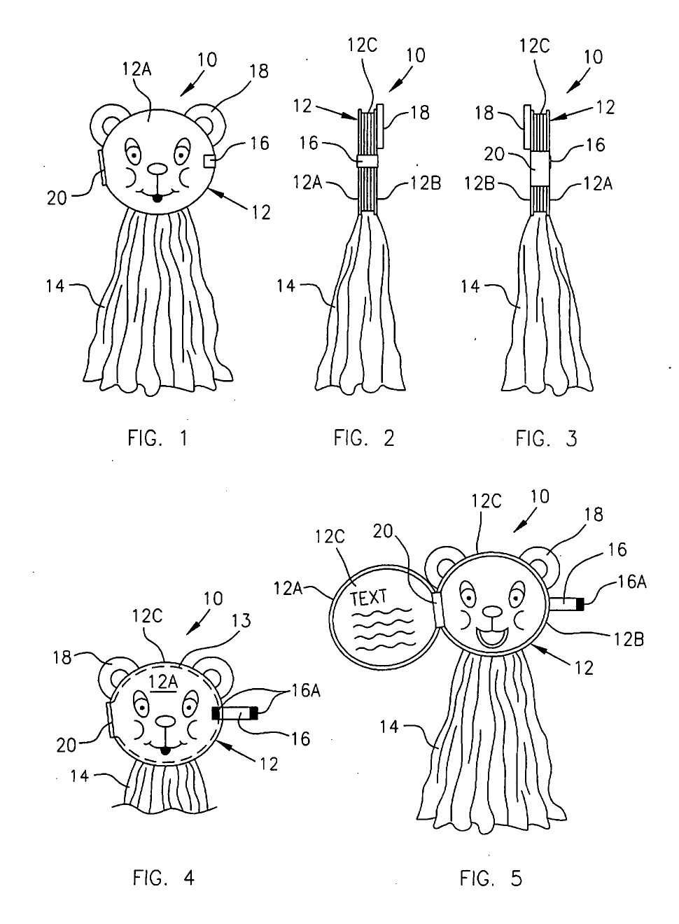

FIG. 1 illustrates, in a front elevation view, a teaching and encouraging apparatus 10, the apparatus 10 comprising a book 12 and a blanket 14 attached to the book 12, wherein the book 12 comprises a front cover 12A, a back cover 12B, and at least one page 12C, the blanket 14 may be attached at a lower portion of the back cover 12B, wherein the blanket 14 visually functions as a portrayal of an animal body. The book 12 preferably comprises an approximate diameter in a preferable range of approximately 6.5 inches. A young child may play with, and become emotionally attached to, the apparatus 10. The portrayal of the animal head in the present invention comprises any animal head and is not limited to the examples as herein shown and described. The at least one page 12C preferably comprises approximately 8 pages. The blanket 14 preferably comprises an area in a range of approximately 12″× approximately 12″, although a larger or a smaller area is also within the scope of the present invention. The blanket 14 may comprise at least one feature such as at least one color (not shown), at least one print (not shown), and at least one blanket binding (not shown).

FIG. 2 illustrates, in a side elevation view, a teaching and encouraging apparatus 10, as shown in FIG. 1, the apparatus 10 comprising a book 12 and a blanket 14 attached to the book 12, in accordance with the present invention. The apparatus 10 may further comprise a closure 16 for maintaining the book 12 in a closed position when the book 12 is not in use. The closure 16 may comprise a cloth strip and at least one fastener 16, the at least one fastener 16 being attached to the cloth strip.

FIG. 3 illustrates, in an opposing side elevation view, a teaching and encouraging apparatus 10, as shown in FIG. 1, the apparatus 10 comprising a book 12 and a blanket 14 attached to the book 12, in accordance with the present invention. The book 12 may further comprise a book binding 20, wherein the book binding 20 may be reinforced to withstand the rigors of child's play.

FIG. 4 illustrates, in a front cut-away enlarged view, a teaching and encouraging apparatus 10, as shown in FIG. 1, the apparatus 10 comprising a book 12 and a blanket 14 attached to the book 12, in accordance with the present invention. The at least one fastener 16 comprises a hook and loop fastener 16A, such as Velcro®, by example only, for facilitating manipulation by a young child (not shown). The at least one fastener 16 can be any fastening structure which has characteristics which are safe for children and is resistant to swallowing by a child. Also, the front cover 12A may optionally comprise a reinforcement stitching 13.

FIG. 5 illustrates, in a front elevation view, a teaching and encouraging apparatus 10, as shown in FIG. 1, the apparatus 10 comprising a book 12 and a blanket 14 attached to the book 12, in accordance with the present invention. The book 12 comprises a portrayal of an animal head disposed on the front cover 12A, wherein the animal head portrayal comprises a bear head portrayal, by example only, and wherein the front cover 12A, in particular, comprises a portrayal of an animal face and the back cover 12B, in particular, comprises a pair of ears 18, in accordance with the present invention. The front cover 12A is opened to display opposing pages, wherein the at least one page 12C comprises a plurality of pages, i.e., a left page and a right page, wherein the left page may comprise literary matter and the right page may comprise illustrative matter, or vice versa. The literary matter may comprise text regarding a story or a story line. The illustrative matter comprises a feature, such as at least one illustration relating the story or the story line and the animal face having an alternate expression, by example only. Also, the at least one page 12C may comprise a combination of literary matter and illustrative matter.

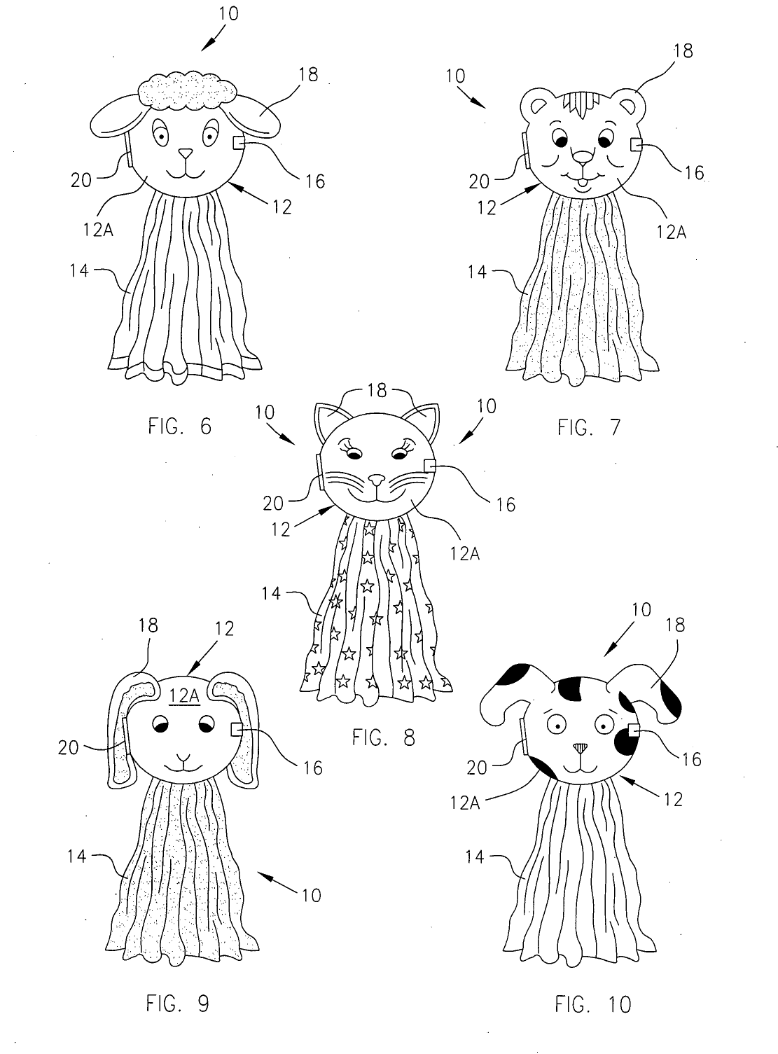

FIG. 6 illustrates, in a front elevation view, a teaching and encouraging apparatus 10, the apparatus 10 comprising a book 12 and a blanket 14 attached to the book 12, wherein the book 12 comprises a portrayal of an animal head, wherein the animal head portrayal comprises a lamb head portrayal, by example only, wherein the book 12 comprises a front cover 12A and a back cover 12B, and wherein the front cover 12A comprises a face and the back cover 12B comprises a pair of ears 18, in accordance with an alternative embodiment of the present invention.

FIG. 7 illustrates, in a front elevation view, a teaching and encouraging apparatus 10, the apparatus 10 comprising a book 12 and a blanket 14 attached to the book 12, wherein the book 12 comprises a portrayal of an animal head, wherein the animal head portrayal comprises a tiger head portrayal, by example only, wherein the book 12 comprises a front cover 12A and a back cover 12B, and wherein the front cover 12A comprises a face and the back cover 12B comprises a pair of ears 18, in accordance with an alternative embodiment of the present invention.

FIG. 8 illustrates, in a front elevation view, a teaching and encouraging apparatus 10, the apparatus 10 comprising a book 12 and a blanket 14 attached to the book 12, wherein the book 12 comprises a portrayal of an animal head, wherein the animal head portrayal comprises a kitten head portrayal, by example only, wherein the book 12 comprises a front cover 12A and a back cover 12B, and wherein the front cover 12A comprises a face and the back cover 12B comprises a pair of ears 18, in accordance with an alternative embodiment of the present invention.

FIG. 9 illustrates, in a front elevation view, a teaching and encouraging apparatus 10, the apparatus 10 comprising a book 12 and a blanket 14 attached to the book 12, wherein the book 12 comprises a portrayal of an animal head, wherein the animal head portrayal comprises a bunny head portrayal, by example only, wherein the book 12 comprises a front cover 12A and a back cover 12B, and wherein the front cover 12A comprises a face and the back cover 12B comprises a pair of ears 18, in accordance with an alternative embodiment of the present invention.

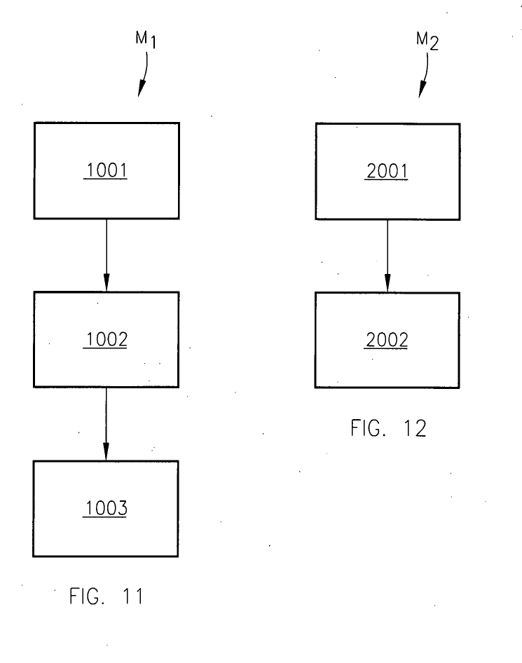

FIG. 10 illustrates, in a front elevation view, a teaching and encouraging apparatus 10, the apparatus 10 comprising a book 12 and a blanket 14 attached to the book 12, wherein the book 12 comprises a portrayal of an animal head, wherein the animal head portrayal comprises a puppy head portrayal, by example only, wherein the book 12 comprises a front cover 12A and a back cover 12B, and wherein the front cover 12A comprises a face and the back cover 12B comprises a pair of ears 18, in accordance with an alternative embodiment of the present invention.

FIG. 11 illustrates, in a flowchart, a method Ml of fabricating an apparatus 10 for teaching and encouraging reading in a young child, in accordance with the present invention. The method M₁ of fabricating the present apparatus generally comprises the steps of: providing a book 12, as indicated by block 1001; providing a blanket 14, as indicated by block 1002; and attaching the blanket 14 to the book 12, as indicated by block 1003, wherein the book 12 providing step 1001 comprises providing a huggable toy, e.g., having a nap and/or a cushioning feature, providing literary matter that appeals to a young child, and providing illustrative matter that appeals to a young child, wherein the blanket 14 providing step 1002 comprises providing a snuggly blanket, e.g., having a nap and/or a cushioning feature, wherein the attaching step 1003 comprises permanently attaching the blanket 14 to the book 12, wherein the literary matter providing step comprises providing at least one element such as a story and a story line, wherein the illustrative matter comprises at least one illustration, thereby providing the young child with oft-sought surrogate comfort and affection, and thereby seizing a learning opportunity for the young child, in accordance with the present invention. The book providing step 1001 may further comprise providing a huggable toy, wherein the huggable toy providing step comprises providing an element such as an animal head and an animal face.

FIG. 12 is a flowchart for a method M₂ of teaching and encouraging reading in a young child by way of a teaching and encouraging apparatus 10, in accordance with the present invention. The method M₂ of teaching and encouraging reading in a young child by way of a teaching and encouraging apparatus 10 generally comprises the steps of: carrying the apparatus by the young child throughout the day, as indicated by block 2001; and taking the apparatus to bed by the young child as a nightly ritual, as indicated by block 2002. The carrying and the taking steps may each comprise the steps of opening, reading, and closing the book 12.

Information as herein shown and described in detail is fully capable of attaining the above-described object of the invention, the presently preferred embodiment of the invention, and is, thus, representative of the subject matter which is broadly contemplated by the present invention. The scope of the present invention fully encompasses other embodiments which may become obvious to those skilled in the art, and is to be limited, accordingly, by nothing other than the appended claims, wherein reference to an element in the singular is not intended to mean “one and only one” unless explicitly so stated, but rather “one or more.” All structural and functional equivalents to the elements of the above-described preferred embodiment and additional embodiments that are known to those of ordinary skill in the art are hereby expressly incorporated by reference and are intended to be encompassed by the present claims.

Moreover, no requirement exists for a device or method to address each and every problem sought to be resolved by the present invention, for such to be encompassed by the present claims. Furthermore, no element, component, or method step in the present disclosure is intended to be dedicated to the public regardless of whether the element, component, or method step is explicitly recited in the claims. However, various changes and modifications in form, material, and fabrication material detail may be made without departing from the spirit and scope of the inventions as set forth in the appended claims should be readily apparent to those of ordinary skill in the art. No claim herein is to be construed under the provisions of 35 U.S.C. §112, sixth paragraph, unless the element is expressly recited using the phrase “means for.”

### INDUSTRIAL APPLICABILITY

The present invention industrially applies scholastic and home-schooling industries. In particular, the present invention industrially applies to apparatuses and methods for encouraging young children to read. More particularly, the present invention industrially applies to literary and illustrative apparatuses, and methods, for encouraging young children to read. Even more particularly, the present invention industrially applies to literary and illustrative apparatuses, having a comforting feature, and methods for encouraging young children to read.

What is claimed:

1. An apparatus for teaching and encouraging reading, the apparatus comprising:
a book having a front cover, a back cover, and at least one page; and
a blanket attached to the book.

2. An apparatus, as recited in claim 1, wherein the blanket is attached at a lower portion of the back cover.

3. An apparatus, as recited in claim 1, wherein the book comprises a portrayal of an animal head disposed on the front cover.

4. An apparatus, as recited in claim 3, wherein the blanket visually functions as a portrayal of an animal body.

5. An apparatus, as recited in claim 1,
wherein the book comprises a diameter in a range of approximately 6.5 inches,
wherein the at least one page comprises approximately 8 pages,
wherein the blanket comprises an area in a range of approximately 12 inches by approximately 12 inches, and
wherein the blanket comprises at least one feature selected from a group consisting essentially of at least one color, at least one print, and at least one blanket binding.

6. An apparatus, as recited in claim 1, further comprising a closure for maintaining the book in a closed position when the book is not in use.

7. An apparatus, as recited in claim 6, wherein the closure comprises:
a cloth strip; and
at least one fastener for facilitating manipulation by a user, the at least one fastener being attached to the cloth strip.

8. An apparatus, as recited in claim 7, wherein the at least one fastener comprises a hook and loop fastener.

9. An apparatus, as recited in claim 1, wherein the book comprises a book binding.

10. An apparatus, as recited in claim 9, wherein the book binding is reinforced to withstand the rigors of child's play.

11. An apparatus, as recited in claim 3, wherein the animal head portrayal comprises an animal face portrayal disposed on the front cover and a pair of ears portrayal attached to the back cover.

12. An apparatus, as recited in claim 3, wherein the animal head portrayal comprises at least one feature selected from a group consisting essentially of a bear head portrayal, a bear cub head portrayal, a sheep portrayal, a lamb head portrayal, a cat head portrayal, a kitten head portrayal, a rabbit head portrayal, a bunny head portrayal, a dog head portrayal, a puppy head portrayal, tiger head portrayal, and a tiger cub head portrayal.

13. An apparatus, as recited in claim 1,
wherein the front cover is opened for displaying opposing pages,
wherein one opposing page comprises at least one feature selected from a group consisting essentially of literary matter and illustrative matter, and
wherein the other opposing page comprises at least one feature selected from a group consisting essentially of literary matter and illustrative matter.

14. An apparatus, as recited in claim 13,
wherein the literary matter comprises text relating to at least one item selected from a group consisting essentially of a story and a story line, and
wherein the illustrative matter comprises a feature selected from a group consisting essentially of at least one illustration and an animal face portrayal having an alternate expression.

15. An apparatus for teaching and encouraging reading, the apparatus comprising:
a book having a front cover, a back cover, and at least one page;
a blanket attached to the book; and
a closure for maintaining the book in a closed position when the book is not in use,
wherein the blanket is attached at a lower portion of the back cover,
wherein the book comprises a portrayal of an animal head disposed on the front cover.
wherein the blanket visually functions as a portrayal of an animal body,
wherein the closure comprises:
a cloth strip; and
at least one fastener for facilitating manipulation by a user, the at least one fastener being attached to the cloth strip,
wherein the at least one fastener comprises a hook and loop fastener,
wherein the book comprises a book binding,
wherein the book binding is reinforced to withstand the rigors of child's play,
wherein the animal head portrayal comprises an animal face portrayal disposed on the front cover and a pair of ears portrayal attached to the back cover,
wherein the animal head portrayal comprises at least one feature selected from a group consisting essentially of a bear head portrayal, a bear cub head portrayal, a sheep portrayal, a lamb head portrayal, a cat head portrayal, a kitten head portrayal, a rabbit head portrayal, a bunny head portrayal, a dog head portrayal, a puppy head portrayal, tiger head portrayal, and a tiger cub head portrayal,
wherein the front cover is opened to display opposing pages,
wherein one opposing page comprises at least one feature selected from a group consisting essentially of literary matter and illustrative matter,
wherein the other opposing page comprises at least one feature selected from a group consisting essentially of literary matter and illustrative matter,
wherein the literary matter comprises text relating to at least one item selected from a group consisting essentially of a story and a story line, and
wherein the illustrative matter comprises a feature selected from a group consisting essentially of at least one illustration and an animal face portrayal having an alternate expression.

16. A method of fabricating an apparatus for teaching and encouraging reading, the fabricating method comprising the steps of:
providing a book having a front cover, a back cover, and at least one page;
providing a blanket; and
attaching the blanket to the book.

17. A method, as recited in claim 16, wherein the attaching step comprises attaching the blanket at a lower portion of the back cover.

18. A method, as recited in claim 16, wherein the book providing step comprises providing a portrayal of an animal head disposed on the front cover.

19. A method, as recited in claim 18, wherein the blanket providing step comprises providing the blanket in a manner such that the blanket visually functions as a portrayal of an animal body.

20. A method, as recited in claim 16,
wherein the book providing step comprises at least one step selected from a group consisting essentially of providing the book with a diameter in a range of approximately 6.5 inches and providing the at least one page comprising approximately 8 pages,
wherein the blanket providing step comprises providing the blanket with an area in a range of approximately 12 inches by approximately 12 inches, and
wherein the blanket providing step comprises providing the blanket with at least one feature selected from a group consisting essentially of at least one color, at least one print, and at least one blanket binding.

21. A method, as recited in claim 16, further comprising providing a closure for maintaining the book in a closed position when the book is not in use.

22. A method, as recited in claim 21, wherein the closure providing step comprises:
providing a cloth strip; and
providing at least one fastener for facilitating manipulation, the at least one fastener being attached to the cloth strip.

23. A method, as recited in claim 22, wherein the at least one fastener providing step comprises providing a hook-and-loop fastener.

24. A method, as recited in claim 16, wherein the book providing step comprises providing a book binding.

25. A method, as recited in claim 24, wherein the book binding providing step comprises reinforcing the book binding to withstand the rigors of child's play.

26. A method, as recited in claim 18, wherein the animal head portrayal providing step comprises providing an animal face portrayal disposed on the front cover and a pair of ears portrayal attached to the back cover.

27. A method, as recited in claim 18, wherein the animal head portrayal providing step comprises providing at least one feature selected from a group consisting essentially of a bear head portrayal, a bear cub head portrayal, a sheep portrayal, a lamb head portrayal, a cat head portrayal, a kitten head portrayal, a rabbit head portrayal, a bunny head portrayal, a dog head portrayal, a puppy head portrayal, tiger head portrayal, and a tiger cub head portrayal.

28. A method, as recited in claim 16,
wherein book providing step comprises providing the front cover being openable to display opposing pages,
wherein book providing step comprises providing one opposing page with at least one feature selected from a group consisting essentially of literary matter and illustrative matter, and
wherein book providing step comprises providing the other opposing page with at least one feature selected from a group consisting essentially of literary matter and illustrative matter.

29. A method, as recited in claim 28,
wherein book providing step comprises providing the literary matter as text relating to at least one item selected from a group consisting essentially of a story and a story line, and
wherein book providing step comprises providing the illustrative matter as a feature selected from a group consisting essentially of at least one illustration and an animal face portrayal having an alternate expression.

30. A method of teaching and encouraging reading by way of a teaching and encouraging apparatus, the method comprising the steps of:
carrying the apparatus throughout the day by a user; and
taking the apparatus to bed as a nightly ritual by the user.

31. A method, as recited in claim 30, wherein the carrying step and the taking step each comprises the steps of opening, reading, and closing the book.

32. A method, as recited in claim 30, wherein the user plays with, and becomes emotionally attached to, the apparatus for facilitating the teaching and encouragement of reading.
